(19) United States
(12) Patent Application Publication
(10) Pub. No.: US 2003/0061030 A1
(43) Pub. Date: Mar. 27, 2003

(54) Natural language processing apparatus, its control method, and program

(75) Inventors: Hideo Kuboyama, Kanagawa (JP); Makoto Hirota, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/247,306

(22) Filed: Sep. 20, 2002

(30) Foreign Application Priority Data
Sep. 25, 2001 (JP) 2001-291859

(51) Int. Cl. G06F 17/27

(52) U.S. Cl. 704/9

(57) ABSTRACT

An apparatus stores a correct answer corpus (103) that describes correct answers of morphological analysis for a huge volume of text, and has morphological analysis means (101) for executing morphological analysis of respective sentences in the correct answer corpus (103) using a connection cost table (102), detection means (106) for detecting error parts of the morphological analysis, and correction means (107) for correcting connection cost information in the connection cost table (102) corresponding to the error parts. In this manner, connection cost learning that can implement morphological analysis with higher precision can be made.

### FIELD OF THE INVENTION

The present invention relates to a natural language processing apparatus for analyzing text and its control method, and a program.

### BACKGROUND OF THE INVENTION

Morphological analysis is a technique required in various fields such as speech synthesis, information search, and the like. Morphological analysis is the first step of a natural language process, and phrase relation analysis, pronunciation, semantic analysis, context analysis, and the like are made based on the morphological analysis result.

In the method of morphological analysis, how to select probable words from a plurality of words that appear upon looking up a dictionary at respective character positions, and line them up from the beginning to the end of a sentence is the core of a technique. As one scheme, a method of setting a connection cost as a weight for connection between classes, which are classified based on words, parts of speech, or word information, as units, holding a table of connection costs as information, and selecting a word sequence that minimizes (or maximizes depending on the way costs are defined) the total cost from the beginning to the end of a sentence is available. As a method of setting the connection cost, a large-scale correct answer corpus is researched to obtain a connection probability between respective units, and a connection cost is set based on that value.

However, even when each connection cost is set based on the statistical probability of connection between respective words, since one word sequence is finally selected based on the total cost of the whole sentence, an error may be selected as a comparison result of the total costs of the whole sentence. When an intra-class word cost or insertion penalty assigned to specific or all words is added to the cost calculation in addition to the connection cost, an error may be selected due to the influence of delicate balance among these cost values. For this reason, connection cost information stored in a natural language processing apparatus is often not appropriate in terms of the precision of the morphological analysis result. Hence, means for correcting inappropriate connection costs, and statistically learning them is required.

As for learning of connection costs, for example, Japanese Patent Laid-Open Nos. 5-12327 and 09-114825 have proposed a method of outputting a plurality of candidates upon morphological analysis, designating a correct answer from them, and correcting and learning connection costs. However, since a correct answer is selected to learn connection costs upon morphological analysis of one sentence, the learned connection costs do not always assume statistically appropriate values for a huge volume and variety of text.

### SUMMARY OF THE INVENTION

It is, therefore, an object of the present invention to make connection cost learning that can implement morphological analysis with higher precision.

The present invention is an apparatus and method that performs connection cost learning that can implement morphological analysis with higher precision. The apparatus stores a correct answer corpus that describes correct answers of morphological analysis for a huge volume of text, and includes morphological analysis means for executing morphological analysis of respective sentences in the correct answer corpus using a connection cost table, detection means for detecting error parts of the morphological analysis, and correction means for correcting connection cost information in the connection cost table corresponding to the error parts.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a functional block diagram of a natural language processing apparatus according to the first embodiment of the present invention;

FIG. 2 shows the contents of morphological analysis in the first embodiment of the present invention;

FIG. 3 shows an example of the structure of a connection cost table in the first embodiment of the present invention;

FIG. 4 is a flow chart showing an inter-class connection cost learning process in the first embodiment of the present invention;

FIG. 5 shows an example of a correct answer corpus in the first embodiment of the present invention;

FIG. 6 is a view for explaining an error detection process in the first embodiment of the present invention;

FIG. 7 is a view for explaining a connection cost correction process in the first embodiment of the present invention;

FIG. 8 is a view for explaining a connection cost correction process and connection cost update process in the first embodiment of the present invention;

FIG. 9 is a flow chart showing details of the connection cost correction process in the first embodiment of the present invention;

FIG. 10 is a functional block diagram of a natural language processing apparatus according to the second embodiment of the present invention;

FIG. 11 shows an example of allowable error pattern information in the second embodiment of the present invention;

FIG. 12 is a view for explaining allowable error pattern information in the second embodiment of the present invention;

FIG. 13 is a functional block diagram of a connection cost learning apparatus according to the third embodiment of the present invention; and

FIG. 14 is a block diagram showing the hardware arrangement of a personal computer, which serves as a natural language processing apparatus according to an embodiment of the present invention.

### DESCRIPTION OF THE PREFERRED EMBODIMENTS

Preferred embodiments of the present invention will be described in detail hereinafter with reference to the accompanying drawings.

(First Embodiment)

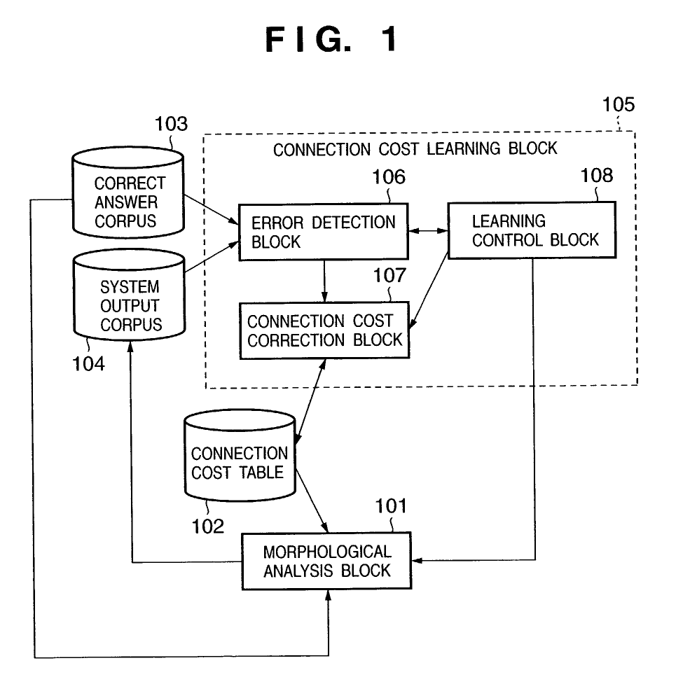

FIG. 1 is a functional block diagram of a natural language processing apparatus of this embodiment.

Referring to FIG. 1, reference numeral 101 denotes a morphological analysis block for analyzing text and decomposing it into words (morphemes).

Reference numeral 102 denotes a connection cost table used in morphological analysis of the morphological analysis block 101.

Reference numeral 103 denotes a correct answer corpus as a set of correct answers obtained by correctly morphologically analyzing text.

Reference numeral 104 denotes a system output corpus as a set of outputs obtained by morphologically analyzing a set of originals of the correct answer corpus by the morphological analysis block 101.

Reference numeral 105 denotes a connection cost learning block for learning the connection cost table 102 using the correct answer corpus 103 and system output corpus 104. The connection cost learning block 105 comprises the following three blocks 106 to 108. That is, reference numeral 106 denotes an error detection block for detecting an error part by comparing the correct answer corpus 103 and system output corpus 104. Reference numeral 107 denotes a connection cost correction block for correcting a connection cost between morphemes in the error part, and updating the connection cost table 102. Reference numeral 108 denotes a learning control block for determining the end of learning.

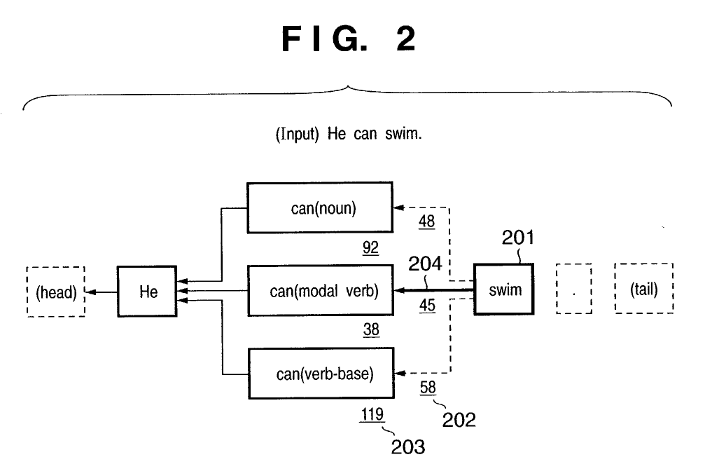

FIG. 2 shows the contents of morphological analysis executed by the morphological analysis block 101. In FIG. 2, a block 201 indicated by a bold frame indicates the current morpheme of interest of the morphological analysis block 101. Reference numeral 202 denotes connection costs generated between the morpheme 201 and immediately preceding morphemes, and their values are assigned to respective connection routes. Reference numeral 203 denotes accumulated costs that the immediately preceding morphemes of the morpheme 201 of interest have, and their values are assigned to the immediately preceding morphemes. A route 204 indicated by the solid line is an optimal path selected by the morpheme 201 of interest by analysis.

Morphological analysis in this embodiment will be explained below using FIG. 2.

The morphological analysis block 101 makes analysis while looking up a dictionary in turn from the beginning of a sentence. The morpheme 201 of interest calculates accumulated costs from the beginning of the sentence to the morpheme of interest for immediately preceding morphemes, and selects one path with the smallest accumulated cost. Since the immediately preceding morphemes have already calculated the accumulated costs 203 until them, and have already selected optimal paths, the accumulated cost until the morpheme 201 of interest is calculated by:

(accumulated cost 203 until immediately preceding morpheme)+(connection cost 202)+(word cost of morpheme 201 of interest)

Note that the word cost of the morpheme 201 of interest is a cost which is generated depending only on a word and is assigned to each word. For this reason, the optimal path 204 can be determined by calculating only the first and second terms of the above formula. In FIG. 2, a morpheme “can (modal-verb)” is selected as an optimal path, and the calculated accumulated cost is appended to a morpheme “swim” as information. When this process is done from the beginning to the end of the sentence, a unique optimal path that runs from the beginning to the end of the sentence is selected upon completion of the process at the end of the sentence.

Note that the connection cost between morphemes is held in the connection cost table 102. Morphemes are classified into units called classes on the basis of detailed information such as parts of speech and the like, which represent grammatical and semantic features, and a connection cost is assigned between respective classes.

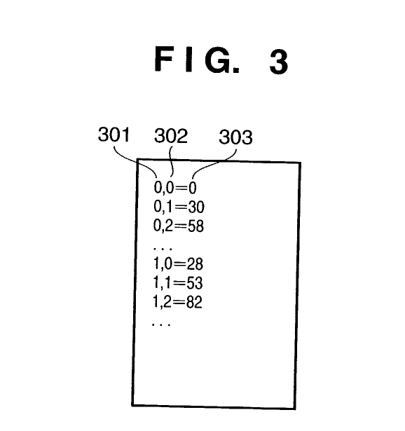

FIG. 3 shows an example of the structure of the connection cost table 102.

Reference numeral 301 denotes a number that represents a class of an antecedent morpheme. Reference numeral 302 denotes a number that represents a class of a consequent morpheme. Reference numeral 303 denotes a value of a connection cost determined for a pair of classes of antecedent and consequent morphemes.

For example,

0, 0=0

described in the first row in FIG. 3 indicates that the connection cost between a morpheme of class 0 and a morpheme of class 0 is 0. Also,

0, 1=30

described in the second row indicates that the connection cost between a morpheme of class 0 and a morpheme of class 1 is 30. Likewise, this connection cost table 102 describes connection costs for respective combinations of connections between classes.

However, as described above, the connection costs set in this table are not always optimized in terms of the precision of the morphological analysis result. Hence, in the embodiment of the present invention, connection costs between classes expressed in this connection cost table 102 are statistically learned.

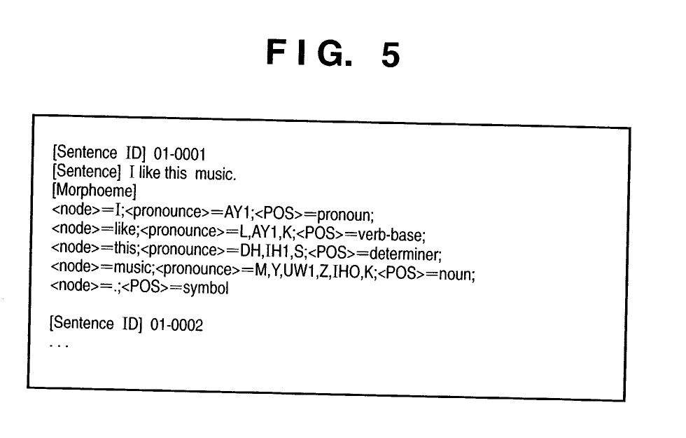

FIG. 5 shows an example of the correct answer corpus 103.

The correct answer corpus 103 describes originals and contents that have undergone correct morphological analysis. As the morphemic contents, an original is described while being divided into morphemes, and the notational position and length in text, notation in text, and the entry, part of speech, and pronunciation in a dictionary are described as information for each morpheme. The system output corpus 104 also describes the analysis result of the same input sentences as those in the correct answer corpus 103 in the same format.

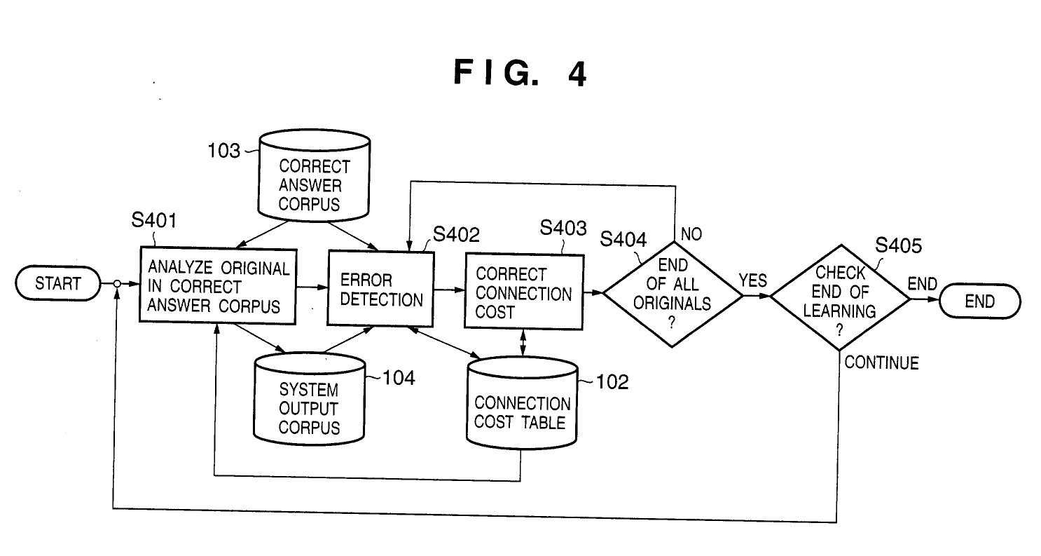

FIG. 4 is a flow chart showing an inter-class connection cost learning process in the connection cost table 102.

In step S401, the morphological analysis block 101 analyzes all sets of originals in the correct answer corpus 103 to generate the system output corpus 104. As described above, the correct answer corpus 103 describes originals before analysis and correct analysis results. To the system output corpus 104, the analysis results of the same input sentences as the correct answer corpus 103 are output in the same format.

In step S402, the error detection block 106 compares the correct answer corpus 103 and system output corpus 104 to detect error parts (details will be explained later). In step S403, the connection cost correction block 107 corrects connection costs between morphemes in each error part, and updates the connection cost table 102. It is then checked in step S404 if the error detection block 106 has made error detection for all originals in the correct answer corpus 103, and the flow returns to step S402 to repeat the above processes until error detection of all originals is completed.

The learning control block 108 checks in step S405 if connection cost learning is to end, or the system output corpus is generated again using the learned connection cost table 102 to repeat learning. More specifically, the error rate in all morphemes of all originals is calculated and recorded for each repetitive learning cycle on the basis of the number of error parts detected by the error detection block 106, and it is checked if the average error rate of N previous cycles largely deviates from a predetermined threshold value. If the average error rate does not deviate from the threshold value, learning is to end; otherwise, the flow returns to step S401 to repeat learning. However, the criterion upon determining if learning is to be repeated or to end is not limited to this, and other criteria may be used.

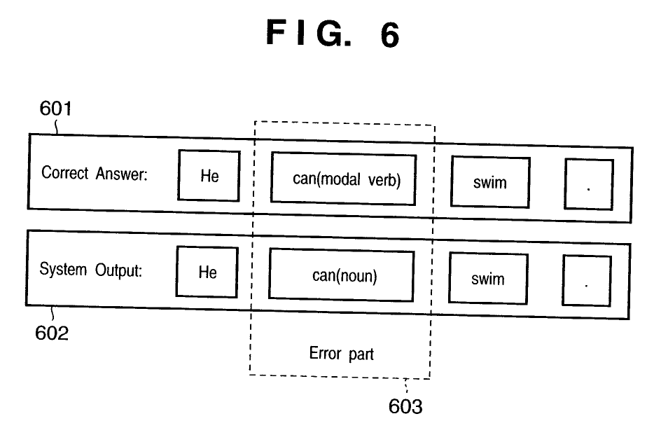

FIG. 6 is a view for explaining the error detection process executed by the error detection block 106 in step S402.

Reference numeral 601 denotes morphemic contents of a given sentence described in the correct answer corpus 103. Reference numeral 602 denotes morphemic contents described in the system output corpus 104 by analyzing an original of 601 by the morphological analysis block 101. The error detection block 106 compares the contents 601 and 602. In case of this example, a part 603 has different analysis results. This part is an error part determined as an error in the system output corpus 104.

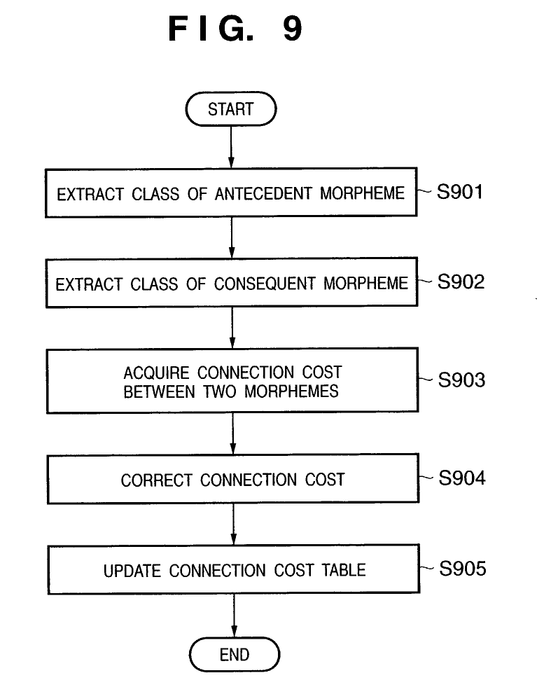

FIG. 9 is a flow chart showing details of the connection cost correction process in step S403.

The class of an antecedent morpheme is read out from the connection cost table 102 in step S901, and that of a consequent morpheme is read out from the connection cost table 102 in step S902. Furthermore, a connection cost between the classes of these morphemes is read out from the connection cost table 102 in step S903.

In step S904, the connection cost is corrected.

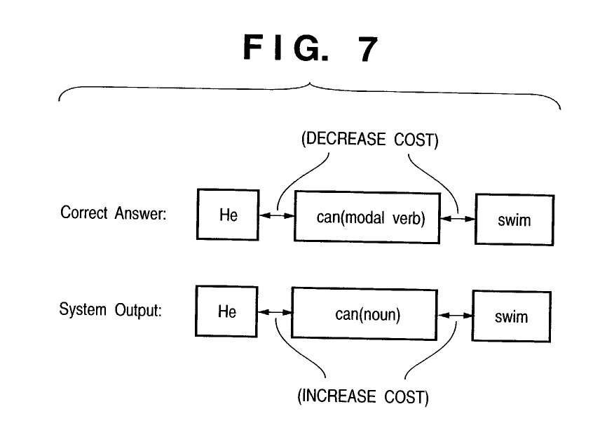

FIG. 7 is a view for explaining the connection cost correction process in this step. FIG. 7 exemplifies a correction process for the error part shown in FIG. 6.

All connection costs between the morpheme detected by the error detection block 106, and its two neighboring morphemes are corrected. More specifically, each connection cost between morphemes in the correct answer corpus 103 is decreased by multiplying it by 1/(1+α) (for α≧0), and each connection cost between morphemes in the system output corpus 104 is increased by multiplying it by (1+α). However, the connection cost adjustment method is not limited to such specific method, and other adjustment methods may be used.

In morphological analysis in this embodiment, a word sequence that minimizes the accumulated cost of one sentence is selected as an analysis result, as described above. By contrast, if a word sequence with the maximum accumulated connection cost is determined to be a probable sentence, an increase/decrease in connection cost upon correcting the connection cost is reversed.

In step S905, the connection cost table 102 is updated by the corrected connection costs.

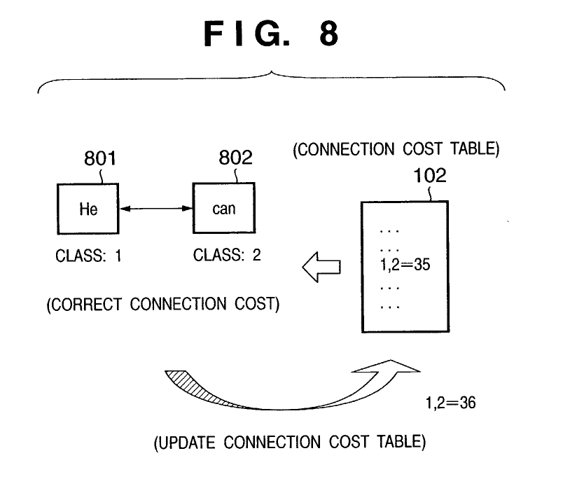

FIG. 8 is a view for explaining the connection cost correction process in step S904 and the connection cost update process in step S905.

Reference numeral 801 denotes an antecedent morpheme of an error part in the system output corpus 104; and 802, a consequent morpheme. Respective morphemes are classified based on classes representing their features, and the connection cost table 102 describes connection costs, each of which is assigned to a pair of classes of the antecedent and consequent morphemes (FIG. 3), as described above. A connection cost between the antecedent and consequent morphemes 801 and 802 can be acquired from the connection cost table 102. The acquired connection cost is corrected by the process in step S904, and the corresponding contents of the connection cost table 102 are updated by the corrected cost.

According to the aforementioned embodiment, the correct answer corpus which describes correct answers of morphological analysis of a huge volume and variety of text is stored, and respective sentences in that correct answer corpus can undergo morphological analysis to correct analysis errors. As a result, the learned connection costs can assume statistically appropriate values.

(Second Embodiment)

In the first embodiment, the error detection block 106 detects all differences between the correct answer corpus 103 and system output corpus 104 as error parts.

However, for example, when text contains a word “east-coast”, and the correct answer corpus 103 describes “east-coast” as one word, even if the system output corpus 104 divisionally analyzes this word as “east” and “coast”, it is improper to linguistically determine this analysis as an error.

Hence, this embodiment provides a mechanism for allowing errors of specific patterns as correct answers.

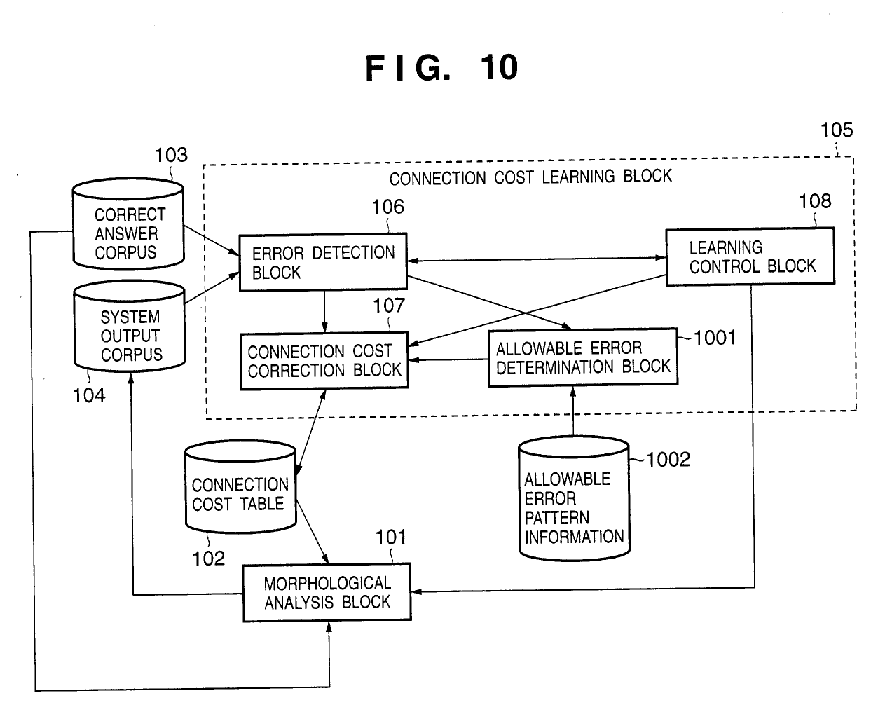

FIG. 10 is a functional block diagram of a natural language processing apparatus which has a mechanism that allows errors of specific patterns as correct answers. The same reference numerals in FIG. 10 denote the same blocks common to those in FIG. 1. Upon comparison with the functional block diagram of FIG. 1, an allowable error determination block 1001 is added to the connection cost learning block 105. This allowable error determination block 1001 acquires information from allowable error pattern information 1002, which describes in advance patterns allowed as correct answers, even when morphemic contents are different between the correct answer corpus 103 and system output corpus 104.

The allowable error determination block 1001 checks if an error part detected by the error detection block 106 matches the allowable error pattern information 1002. If the error part matches the allowable error pattern information 1002, the allowable error determination block 1001 instructs the connection cost correction block 107 not to correct the connection cost.

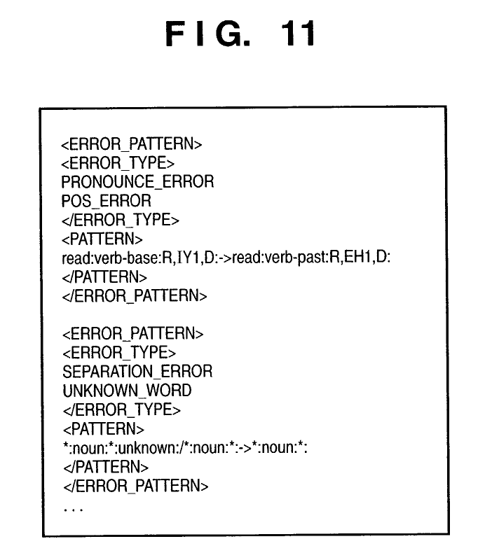

FIG. 11 shows an example of the allowable error pattern information 1002. Allowable patterns are delimited by <ERROR_PATTERN> tags one by one. In each field, the type of error (pronunciation error, part-of-speech error, and the like) is described between <ERROR_TYPE> tags, and an allowable pattern is described between <PATTERN> tags.

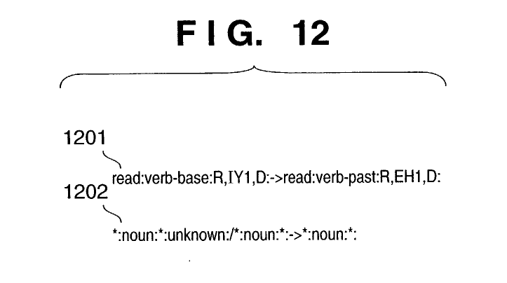

FIG. 12 shows excerpts of allowable patterns described in the allowable error pattern information 1002 shown in FIG. 11. As indicated by 1201 and 1202 in FIG. 12, each allowable pattern describes a pattern of the correct answer corpus 103 on the left-handed side, and that of the system output corpus 104 on the right-handed side on the two sides of symbol “->”. If each pattern is formed of a plurality of morphemes, they are delimited by symbol “/”. Respective pieces of information of a pattern for one morpheme are delimited by “:”; the first term includes a notation, the second term includes a part of speech, the third term includes pronunciation, and the fourth term includes a flag indicating if the word of interest is an unknown word. Symbol “*” indicates that the term can be any pattern. Note that the right- and left-handed sides must have the same notation.

The allowable pattern 1201 indicates that if verb-base “read” is analyzed to be verb-past “read”, such analysis result is allowed as a correct answer. The allowable pattern 1202 indicates that if a two-morpheme pattern of unknown word +noun in the correct answer corpus 103 is analyzed to be one noun, such analysis result is allowed as a correct answer. In this case, the notation and pronunciation are not particularly limited due to the presence of symbol “*”, but the notation as a combination of two morphemes on the left-handed side must match that on the right-handed side.

In this manner, when the aforementioned error pattern appears, the allowable error determination block 1002 allows the error part as a correct answer, thus preventing unnecessary cost correction.

(Third Embodiment)

In the first and second embodiments, the natural language processing apparatus comprises the connection cost learning block 105. However, this connection cost learning block can be implemented as a standalone apparatus.

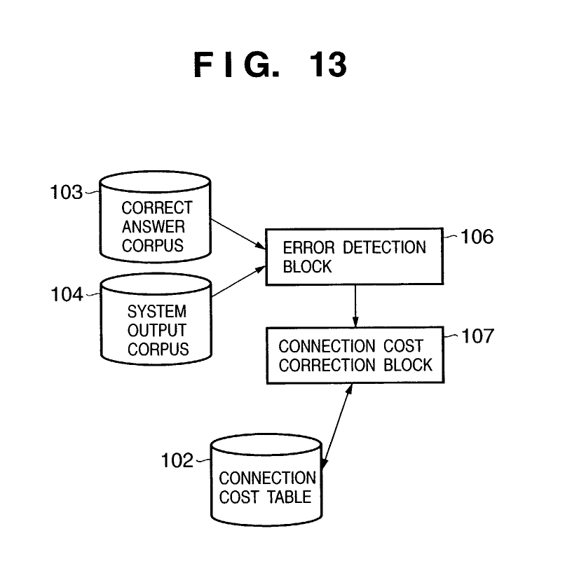

FIG. 13 is a functional block diagram of a connection cost learning apparatus in this embodiment. Note that the same reference numerals in FIG. 13 denote the same blocks as the functional blocks shown in FIG. 1. As shown in FIG. 13, this connection cost learning apparatus comprises the connection cost table 102, correct answer corpus 103, system output corpus 104, error detection block 106, and connection cost correction block 107.

Note that the system output corpus 104 is generated by morphologically analyzing respective originals in the correct answer corpus by another natural language processing apparatus, which comprises the same correct answer corpus as the correct answer corpus 103.

As described above, the error detection block 106 compares the correct answer corpus 103 and system output corpus 104 to detect error parts. After that, the connection cost correction block 107 corrects a connection cost between morphemes in each detected error part, and updates the connection cost table 102.

In this way, the learned connection cost table is generated. When a natural language processing apparatus installs this learned connection cost table, and uses it in analysis, it can provide a high-precision morphological analysis process. If such connection cost learning apparatus is available, the natural language processing apparatus need not comprise any connection cost learning block.

In each of the above embodiments, connection costs are assigned to classes, which are classified based on the features of morphemes. In this case, a unit of class to which a connection cost is assigned is not particularly limited. For example, one word may be considered as a class, or detailed information such as a part of speech, inflection, and the like may be used. Also, different or independent classes may be held when connection costs between a given word, and its antecedent and consequent morphemes are checked. Furthermore, the morphological analysis method is not limited to the method shown in FIG. 2 of the above embodiment. For example, a word cost upon calculating the accumulated cost may be omitted, or a given value may be added to some or all parts of speech of independent words and the like. That is, the present invention can be applied to any methods as long as parameters that indicate the probabilities of connections between classes, morphemes, or parts of speech are held, and morphological analysis is made using such parameters.

The description formats of the connection cost table shown in FIG. 3, the correct answer corpus shown in FIG. 5, and the allowable error pattern information shown in FIG. 11 in the above embodiments are not particularly limited as long as the functions described in these embodiments are satisfied.

The functions of the natural language processing apparatus or connection cost learning apparatus in the above embodiments can be implemented using a computer such as a personal computer or the like.

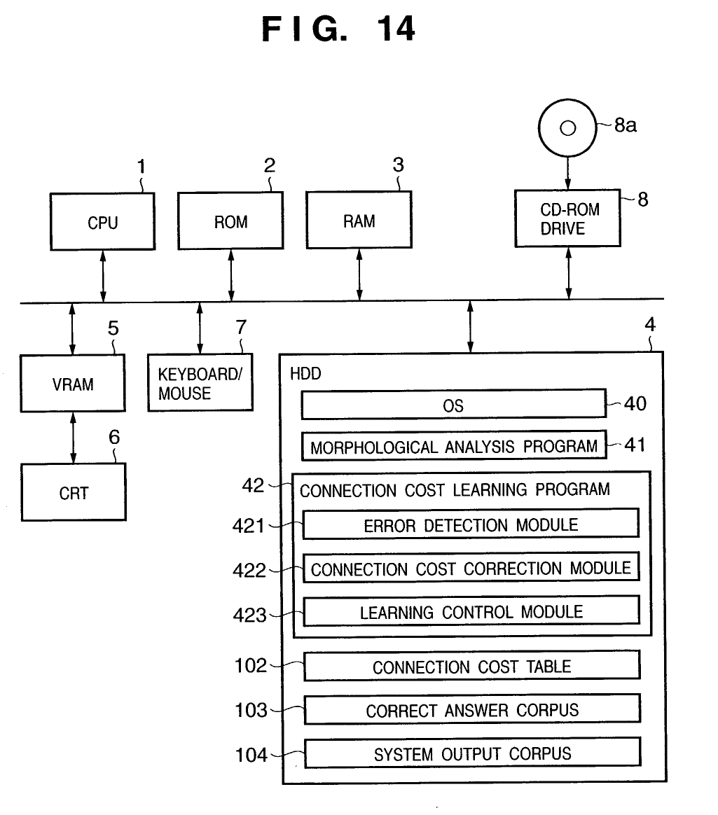

FIG. 14 is a block diagram showing the hardware arrangement of a personal computer which serves as the natural language processing apparatus shown in FIG. 1.

As shown in FIG. 14, the personal computer comprises a CPU 1 for controlling the overall apparatus, a ROM 2 that stores a boot program and the like, and a RAM 3 which serves as a main memory, and also the following arrangement.

An HDD 4 is a hard disk device serving as an external storage device. A VRAM 5 is a memory on which image data to be displayed is rendered. By rendering image data or the like on the VRAM 5, an image can be displayed on a CRT 6. Reference numeral 7 denotes a keyboard/mouse used to make various inputs and/or setups.

On the HDD 4, an OS 40 and the following programs and the like are installed, as shown in FIG. 14.

Morphological analysis program 41

This program implements the function of the morphological analysis unit.

Connection cost learning program 42

This program implements the function of the connection cost learning block 105. The program 42 corresponds to the flow chart shown in FIG. 4, and includes the following modules:

(1) an error detection module 421 for implementing the function of the error detection block 106 (corresponding to step S402 in the flow chart of FIG. 4);

(2) a connection cost correction module 422 for implementing the function of the connection cost correction block 107 (corresponding to step S403 in the flow chart in FIG. 4 and, more particularly, to the flow chart in FIG. 9); and

(3) a learning control module 423 for implementing the function of the learning control block 108 (corresponding to step S405 in the flow chart in FIG. 4).

Connection cost table 102

Correct answer corpus 103

In addition, the system output corpus 104 is generated on the HDD 4 upon execution of the morphological analysis program 41.

Note that the morphological analysis program 41, connection cost learning program 42, connection cost table 102, and correct answer corpus 103 are installed from a CD-ROM 8a via a CD-ROM drive 8.

The OS 40, morphological analysis program 41, and connection cost learning program 42 installed on the HDD 4 are loaded onto the RAM 3 after the power supply of the personal computer is turned on, and are executed by the CPU 1.

As can be seen from the above description, the above arrangement can make the personal computer serve as the natural language processing apparatus according to the present invention. Likewise, the personal computer can serve as the connection cost learning apparatus in the third embodiment.

[Another Embodiment]

The preferred embodiments of the present invention have been explained, and the present invention may be applied to either a system constituted by a plurality of devices (e.g., a host computer, interface device, reader, printer, and the like), or an apparatus consisting of a single equipment (e.g., a copying machine, facsimile apparatus, or the like).

Note that the present invention includes a case wherein the invention is achieved by directly or remotely supplying a program of software that implements the functions of the aforementioned embodiments to a system or apparatus, and reading out and executing the supplied program code by a computer of that system or apparatus.

Therefore, the program code itself installed in a computer to implement the functional process of the present invention using the computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a storage medium for supplying the program, for example, a floppy disk, hard disk, optical disk (CD-ROM, CD-R, CD-RW, DVD, and the like), magnetooptical disk, magnetic tape, memory card, and the like may be used.

As another program supply method, the program of the present invention may be acquired by file transfer via the Internet.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As described above, according to the present invention, connection cost learning that can implement morphological analysis with higher precision can be made.

The present invention is not limited to the above embodiments and various changes and modifications can be made within the spirit and scope of the present invention. Therefore, to apprise the public of the scope of the present invention, the following claims are made.

What is claimed is:

1. A natural language processing apparatus, which executes morphological analysis using connection cost information as a weight for connection between units based on predetermined grammatical classes, comprising:
first storage means for storing the connection cost information;
second storage means for storing correct answers of morphological analysis for predetermined sentences;
morphological analysis means for executing morphological analysis for each of the predetermined sentences;
detection means for detecting an error part of a morphological analysis result by said morphological analysis means with respect to the correct answer; and
correction means for correcting connection cost information between morphemes in said first storage means, which information corresponds to the detected error part.

2. The apparatus according to claim 1, further comprising:
learning control means for controlling to repeat processes of said morphological analysis means, said detection means, and said correction means on the basis of a detection result of said detection means.

3. The apparatus according to claim 2, wherein said learning control means comprises:
calculation means for calculating an error rate on the basis of the number of error parts detected by said detection means; and
first determination means for determining if the error rate is larger than a predetermined threshold value, and
said learning control means controls to repeat the processes when the error rate is larger than the predetermined threshold value.

4. The apparatus according to claim 1, further comprising:
second determination means for determining if the detected error part has an error of a predetermined pattern with respect to the correct answer thereof; and
correction control means for, when the error has the error of the predetermined pattern with respect to the correct answer thereof, controlling said correction means not to correct the error part.

5. The apparatus according to claim 4, wherein said second determination means comprises fourth storage means for storing the predetermined pattern and correct answer in correspondence with each other, and when the detected error part matches correspondence between the predetermined pattern and correct answer, which is stored in said fourth storage means, said second determination means determines that the error part has an error of the predetermined pattern with respect to the correct answer thereof.

6. A method of controlling a natural language processing apparatus, which comprises first storage means for storing connection cost information as a weight for connection between units based on predetermined grammatical classes, and second storage means for storing correct answers of morphological analysis for predetermined sentences, and executes morphological analysis using the connection cost information, comprising:
morphological analysis step of executing morphological analysis for each of the predetermined sentences;
detection step of detecting an error part of a morphological analysis result in the morphological analysis step with respect to the correct answer; and
correction step of correcting connection cost information between morphemes in said first storage means, which information corresponds to the detected error part.

7. The method according to claim 6, further comprising:
learning control step of controlling to execute the morphological analysis step, the detection step, and the correction step again on the basis of a detection result in the detection step.

8. The method according to claim 7, wherein the learning control step comprises:
calculation step of calculating an error rate on the basis of the number of error parts detected in the detection step; and
first determination step of determining if the error rate is larger than a predetermined threshold value, and
the learning control step includes the step of controlling to execute the morphological analysis step, the detection step, and the correction step again when the error rate is larger than the predetermined threshold value.

9. The method according to claim 6, further comprising:
second determination step of determining if the detected error part has an error of a predetermined pattern with respect to the correct answer thereof; and
correction control step of controlling, when the error has the error of the predetermined pattern with respect to the correct answer thereof, the correction step not to correct the error part.

10. A program for controlling a natural language processing apparatus, which comprises first storage means for storing connection cost information as a weight for connection between units based on predetermined grammatical classes, and second storage means for storing correct answers of morphological analysis for predetermined sentences, and executes morphological analysis using the connection cost information, said program making the apparatus execute:
morphological analysis step of executing morphological analysis for each of the predetermined sentences;
detection step of detecting an error part of a morphological analysis result in the morphological analysis step with respect to the correct answer; and
correction step of correcting connection cost information between morphemes in said first storage means, which information corresponds to the detected error part.

11. The program according to claim 10, further making the apparatus execute:
learning control step of controlling to execute the morphological analysis step, the detection step, and the correction step again on the basis of a detection result in the detection step.

12. The program according to claim 11, wherein the learning control step comprises:
calculation step of calculating an error rate on the basis of the number of error parts detected in the detection step; and
first determination step of determining if the error rate is larger than a predetermined threshold value, and
the learning control step includes the step of controlling to execute the morphological analysis step, the detection step, and the correction step again when the error rate is larger than the predetermined threshold value.

13. The program according to claim 10, further making the apparatus execute:
second determination step of determining if the detected error part has an error of a predetermined pattern with respect to the correct answer thereof; and
correction control step of controlling, when the error has the error of the predetermined pattern with respect to the correct answer thereof, the correction step not to correct the error part.

14. A connection cost learning apparatus for supplying learned connection cost information to a natural language processing apparatus, which executes morphological analysis using connection cost information as a weight for connection between units based on predetermined grammatical classes, comprising:
first storage means for storing connection cost information before learning;
second storage means for storing correct answers of morphological analysis for predetermined sentences;
third storage means for storing results of morphological analysis executed for the respective predetermined sentences;
detection means for detecting an error part of a morphological analysis result in said third storage means with respect to the correct answer; and
correction means for correcting connection cost information between morphemes in said first storage means, which information corresponds to the detected error part.

15. The apparatus according to claim 14, further comprising:
determination means for determining if the detected error part has an error of a predetermined pattern with respect to the correct answer thereof; and
correction control means for, when the error has the error of the predetermined pattern with respect to the correct answer thereof, controlling said correction means not to correct the error part.

16. The apparatus according to claim 15, wherein said determination means comprises:
fourth storage means for storing the predetermined pattern and correct answer in correspondence with each other, and
when the detected error part matches correspondence between the predetermined pattern and correct answer, which is stored in said fourth storage means, said determination means determines that the error part has an error of the predetermined pattern with respect to the correct answer thereof.

17. A connection cost learning method of learning connection cost information for morphological analysis that uses the connection cost information as a weight for connection between units based on predetermined grammatical classes, comprising:
a step of preparing a connection cost table that describes connection cost information before learning, a correct answer corpus for storing correct answers of morphological analysis for predetermined sentences, and results of morphological analysis executed for the respective predetermined sentences;
error detection step of detecting an error part of the morphological analysis result with respect to the correct answer; and
correction step of correcting connection cost information between morphemes in the connection cost table, which information corresponds to the detected error part.

18. The method according to claim 17, further comprising:
determination step of determining if the detected error part has an error of a predetermined pattern with respect to the correct answer thereof; and
correction control step of controlling, when the error has the error of the predetermined pattern with respect to the correct answer thereof, the correction step not to correct the error part.

19. A program for making a computer, which stores a connection cost table that describes connection cost information as a weight for connection between units based on predetermined grammatical classes, a correct answer corpus that describes correct answers of morphological analysis for predetermined sentences, and results of morphological analysis executed for the respective predetermined sentences, learn the connection cost information, said program making said computer execute:
error detection step of detecting an error part of the morphological analysis result with respect to the correct answer; and
correction step of correcting connection cost information between morphemes in the connection cost table, which information corresponds to the detected error part.

20. The program according to claim 19, further making said computer execute:
determination step of determining if the detected error part has an error of a predetermined pattern with respect to the correct answer thereof; and
correction control step of controlling, when the error has the error of the predetermined pattern with respect to the correct answer thereof, the correction step not to correct the error part.
